(19) United States
(12) Patent Application Publication
(10) Pub. No.: US 2026/0352452 A1
(43) Pub. Date: Nov. 5, 2026

(54) Shared Key Generation in Continuous-Variable Quantum Key Distribution System

(71) Applicant: NEC Corporation, Minato-ku, Tokyo (JP)

(72) Inventor: Wakako YASUDA, Tokyo (JP)

(73) Assignee: NEC Corporation, Minato-ku, Tokyo (JP)

(21) Appl. No.: 18/441,145

(22) Filed: Feb. 14, 2024

(30) Foreign Application Priority Data
Feb. 21, 2023 (JP) 2023-025204

(51) Int. Cl. H04L 9/08

(52) U.S. Cl. CPC H04L 9/0855; H04L 9/0819; H04L 9/0869

(57) ABSTRACT

A shared key generation technique that can improve error correction performance and key generation rate in CV-QKD is provided. A receiver is configured to: a) set reference bit positions for basis reconciliation with a transmitter, wherein the basis reconciliation generates sifted key quantization data from the received quantization data according to the reference bit positions; b) perform hard decision on the sifted key quantization data to generate a corrected key; c) perform soft-decision error correction processing on the sifted key quantization data to generate error correction information to transmit the error correction information to the transmitter; and d) decide whether synchronization is established or not, based on an error rate between the corrected key and another corrected key generated based on the error correction information at the transmitter.

### INCORPORATION BY REFERENCE

This application is based upon and claims the benefit of priority from Japanese Patent Application No. 2023-025204, filed on Feb. 21, 2023, the disclosure of which is incorporated herein in its entirety by reference.

### BACKGROUND ART

The present invention relates to quantum key distribution techniques, and more particularly to techniques for generating shared key between a transmitter and a receiver.

Quantum key distribution (hereinafter referred to as QKD) is a well-known technique allowing secure key sharing between two remote locations by means of single-photon transmission of a sequence of random numbers as the source of a cryptographic key. The single-photon transmission quantum-mechanically assures that the cryptographic key is leak-proof, and thus achieves a high degree of confidentiality. For this reason, it is expected to be used for cryptographic communications that handle important confidential information.

As shown in FIG. 1, QKD is composed of four steps: 1) very weak light transmission, 2) basis reconciliation, 3) error correction, and 4) privacy amplification.
(1) There are two types of very weak light transmission: discrete-variable QKD (DV-QKD), in which a single photon is transmitted through a quantum channel; and continuous-variable QKD (CV-QKD), in which the quadrature amplitude of the light is modulated and transmitted. In DV-QKD, the presence or absence of a photon is detected using a photon detector, and the cryptographic key is generated from the detected data (see, for example, PTL 1). Accordingly, it requires special devices such as a single-photon generating source and a single-photon detector. In contrast, in CV-QKD, the state of optical field is measured by coherent detection, and the encryption key is generated from the measured data (see, for example, PTL 2). Coherent detection is a commonly used technique in long-haul and large-capacity optical communications, so it can be realized using ordinary optical components. Accordingly, CV-QKD is expected to be less expensive than DV-QKD.
(2) In basis reconciliation, basis information is exchanged between the transmitter and receiver through an optical channel of normal intensity level (classical channel) to sift basis-matched bits from the received information. At that time, it is necessary for the transmitter and receiver to agree on which bit of the transmitted basis information corresponds to which bit transmitted in the quantum channel (establishment of bit position synchronization). PTL 1 discloses a method of establishing bit position synchronization based on the error rate of received information in DV-QKD.
(3) Error correction is performed on the sifted information (sifted key) obtained by basis reconciliation. In PTL 1, hard-decision values are used as input data. The hard decision is a two-level decision with respect to an arbitrary threshold value.
(4) Privacy amplification is the process of generating a new random number sequence (final key) which can be obtained by deleting the amount of information that may have been leaked during key delivery based on a random number (parity calculation bits) generated in the transmitter. An eavesdropper cannot get the final key after the privacy amplification without knowing all of the parity calculation bits.

### Patent Literature

(PTL 1) Japanese Patent No. 4124194

(PTL 2) Japanese Patent Unexamined Publication No. 2019-522394

### SUMMARY

As described above, it is necessary to establish synchronization of bit positions between the transmitter and receiver in a QKD system. The establishment of synchronization of bit positions is a prerequisite for the key generation flow. The final key cannot be generated unless synchronization is established.

PTL 1 discloses a bit position synchronization method based on DV-QKD, which judges the success or failure of establishing bit position synchronization by calculating the bit error rate of the sifted key obtained by hard decision. Accordingly, error correction after having established synchronization is also limited to hard-decision error correction.

Compared with hard-decision error correction, soft-decision error correction is more complex to implement, but is expected to significantly improve error correction performance and increase the key generation rate. However, PTL 1 discloses only a method limited to hard-decision error correction. PTL 2 is silent on error correction for CV-QKD.

Therefore, an object of the present invention is to provide a shared key generation technique that can improve error correction performance and key generation rate in CV-QKD.

According to an aspect of the invention, a communication device connected to another communication device through a first channel and a second channel in a continuous-variable quantum key distribution (CV-QKD) system, the communication device includes: a quantum unit configured to receive signal light from the another communication device through the first channel to generate received quantization data by coherent detection, wherein the signal light is quadrature-modulated according to a first random number sequence and a second random number sequence which have predetermined bit positions at the another communication device; and at least one data processor configured to generate a shared key from the received quantization data by communicating with the another communication device through the second channel, wherein the at least one data processor is further configured to: a) set reference bit positions for basis reconciliation with the another communication device, wherein the basis reconciliation generates sifted key quantization data from the received quantization data according to the reference bit positions ; b) perform hard decision on the sifted key quantization data to generate a corrected key; c) perform soft-decision error correction processing on the sifted key quantization data to generate error correction information to transmit the error correction information to the another communication device through the second channel; and d) decide whether synchronization is established or not, based on an error rate between the corrected key and another corrected key, wherein the another corrected key is generated based on the error correction information at the another communication device.

According to an aspect of the invention, a communication control method at a communication device connected to another communication device through a first channel and a second channel in a continuous-variable quantum key distribution (CV-QKD) system, the method includes: by a quantum unit, receiving signal light from the another communication device through the first channel to generate received quantization data by coherent detection, wherein the signal light is quadrature-modulated according to a first random number sequence and a second random number sequence which have predetermined bit positions at the another communication device; and by at least one data processor, a) setting reference bit positions for basis reconciliation with the another communication device, wherein the basis reconciliation generates sifted key quantization data from the received quantization data according to the reference bit positions; b) performing hard decision on the sifted key quantization data to generate a corrected key; c) performing soft-decision error correction processing on the sifted key quantization data to generate error correction information to transmit the error correction information to the another communication device through the second channel; and d) deciding whether synchronization is established or not, based on an error rate between the corrected key and another corrected key, wherein the another corrected key is generated based on the error correction information at the another communication device.

According to an aspect of the present invention, a method for generating a shared key by continuous-variable quantum key distribution (CV-QKD) between a first communication device and a second communication device connected through a first channel and a second channel, the method includes: a) at the first communication device, transmitting signal light to the second communication device through the first channel, wherein the signal light is quadrature-modulated according to a first random number sequence and a second random number sequence which have predetermined bit positions at the first communication device; b) at the second communication device, generating received quantization data by performing coherent detection of signal light received through the first channel; c) at the second communication device, setting reference bit positions for basis reconciliation with the first communication device, wherein the basis reconciliation generates sifted key quantization data from the received quantization data according to the reference bit positions; d) at the first communication device, generating sifted key data by the basis reconciliation; e) at the second communication device, calculating error correction information by soft-decision error correction processing on the sifted key quantization data, and transmitting the error correction information to the first communication device through the second channel; f) at the first communication device, generating a first corrected key from the sifted key data by error correction processing using the error correction information; g) at the second communication device, generating a second corrected key from the sifted key quantization data by hard-decision processing; and h) at one of the first communication device and the second communication device, deciding whether synchronization is established or not, based on an error rate between the first corrected key and the second corrected key.

According to the present invention, it is possible to improve the error correction performance and the key generation rate by introducing soft-decision error correction to CV-QKD.

### BRIEF DESCRIPTION OF THE DRAWINGS

FIG. 1 is a schematic diagram showing a quantum key generation process in QKD as a background technique.

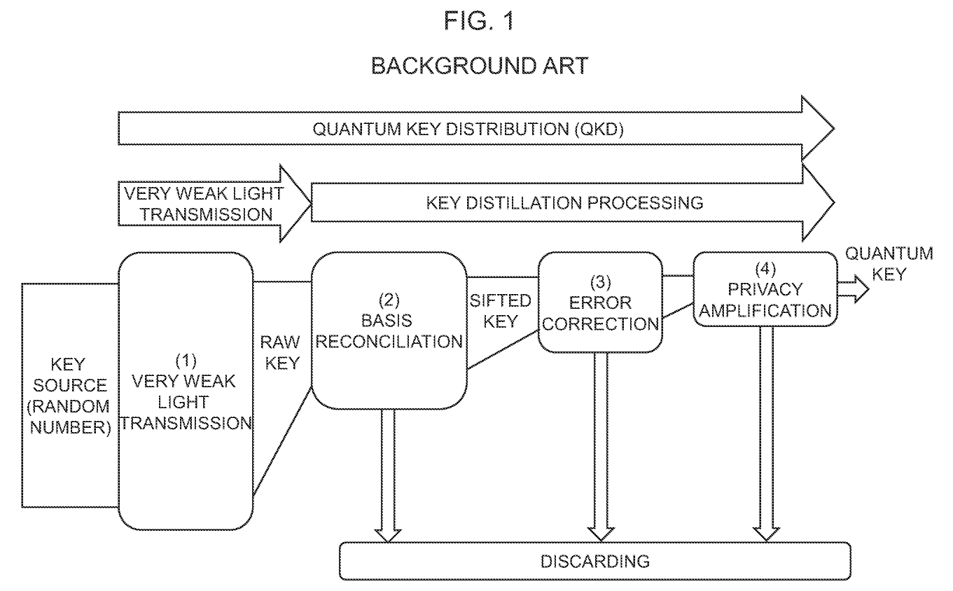

FIG. 2 is a block diagram illustrating a schematic configuration of a CV-QKD system according to an example embodiment of the present invention.

FIG. 3 is a sequence diagram illustrating an outline of a shared information generation method according to the example embodiment.

FIG. 4 is a diagram illustrating an example of the frame structure of transmission bit sequence and basis in the transmitter (Alice).

FIG. 5 is a diagram illustrating an example of the mapping of the transmission bit sequence and basis to I-Q plane in the transmitter (Alice).

FIG. 6 is a schematic diagram illustrating basis reconciliation in the receiver (Bob).

FIG. 7 is a block diagram illustrating the schematic configuration of a CV-QKD system according to a first example of the present invention.

FIG. 8 is a schematic diagram illustrating a shared information generation method in the CV-QKD system according to the first example.

FIG. 9 is a block diagram illustrating the schematic configuration of a CV-QKD system according to a second example of the present invention.

FIG. 10 is a sequence diagram illustrating the shared information generation method in the CV-QKD system according to the second example.

### DETAILED DESCRIPTION

### Outline of example embodiments

It is assumed that a CV-QKD system includes a transmission-side communication device (also referred to as first communication device, another communication device or transmitter) and a reception-side communication device (also referred to as second communication device, communication device or receiver). According to an example embodiment of the present invention, the receiver generates a reception-side corrected key by hard decision from sifted key quantization data and sends, to the transmitter, error correction information (syndrome) calculated by means of soft-decision error correction. The transmitter corrects sifted key data using the error correction information to generate a transmission-side corrected key. In this manner, the corrected keys are generated at both of the receiver and the transmitter. An error rate is calculated based on a part of each corrected key. Based on the error rate, it is decided whether key synchronization is established or not.

As described above, employing soft-decision error correction in CV-QKD improves error correction performance, resulting in increased key generation rate. Hereinafter, the example embodiments and examples of the present invention will be described in detail with reference to the drawings.

### 1. Example embodiment

### 1.1 System configuration

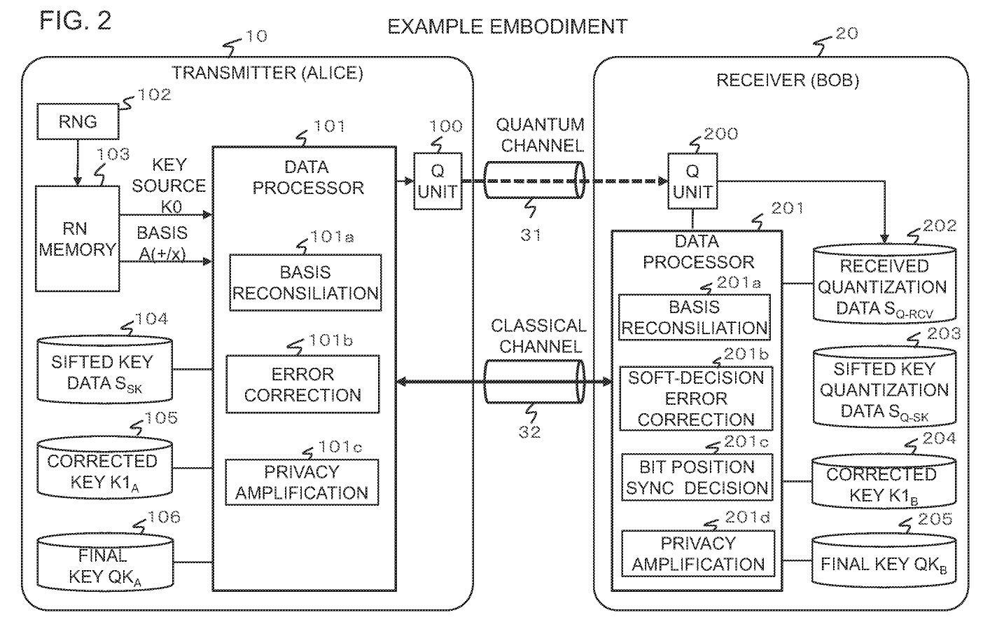

As illustrated in FIG. 2, a QKD system according to the present example embodiment includes a transmitter 10 and a receiver 20, which are connected by a quantum channel 31 and a classical channel 32. Here, the quantum channel 31 is a communication channel through which very weak signal light is transmitted from the transmitter 10 to the receiver 20. The very weak signal light has an optical power of less than 1 photon/bit. Accordingly, the quantum channel is a relatively lossy, noisy and error-prone channel, which means that the quantum channel is less reliable than a normal or classical channel.

The classical channel 32 is a commonly-used communication channel through which optical signals at normal intensities are transmitted. Accordingly, the classical channel 32 is a substantially error-free communication channel and has sufficiently high communication reliability. For this reason, the classical channel 32 is used to exchange information necessary for the transmitter 10 and receiver 20 to perform basis reconciliation, error correction, and privacy amplification. The quantum channel 31 and the classical channel 32 may be physically separate transmission channels, or may be multiplexed into a single optical transmission channel.

The transmitter 10 includes the following functional sections: a quantum (Q) unit 100 that transmits very weak signal light for CV-QKD; a data processor 101 that implements key generation processing functions; a random number generator (RNG) 102; a random number (RN) memory 103; a sifted key data storage section 104; a corrected key storage section 105; and a final key storage section 106. Note that data communication with the receiver 20 through the classical channels may be performed through a communication unit (not shown in FIG. 2).

Random numbers generated by the random number generator 102 are stored in the random number memory 103. The random numbers stored in the random number memory 103 are accessed by the data processor 101 in the key generation process as described below, and are supplied as key source K0 and basis A. Under the control of the data processor 101, the quantum unit 100 transmits very weak signal light quadrature-modulated according to the random numbers (key sources K0 and basis A) to the receiver 20 through the quantum channel 31.

The data processor 101 implements a function of controlling the general transmission operation of the transmitter 10 and a key generation function. The key generation function includes a basis reconciliation section 101a, error correction section 101b, and privacy amplification section 101c, which will be described below. The key generation function may be implemented by software running on a processor such as a CPU (Central Processing Unit), or by hardware such as an FPGA (Field-Programmable Gate Array) or ASIC (Application-Specific Integrated Circuit). The sifted key data S_{S} _{K} generated by the basis reconciliation section 101a is stored in the sifted key data storage section 104. The corrected key K1_{A} which is first shared information generated by the error correction section 101b is stored in the corrected key storage section 105. A final key QK_{A} generated by the privacy amplification section 101c is stored in the final key storage section 106.

The receiver 20 includes a quantum (Q) unit 200 that receives very weak signal light for CV-QKD, a data processor 201 that implements a key generation processing function, a received quantization data storage section 202, a sifted key quantization data storage section 203, a corrected key storage section 204, and a final key storage section 205. Note that data communication with the transmitter 10 through the classical channel 32 may be performed through a communication section (not shown in FIG. 2).

The data processor 201 implements a function of controlling the general reception operation of the receiver 20 and a key generation function. The key generation function includes a basis reconciliation section 201a, soft-decision error correction section 201b, bit-position synchronization decision section 201c, and privacy amplification section 201d, which will be described below. The key generation function may be implemented by software running on a processor such as a CPU (Central Processing Unit) or by hardware such as an FPGA or ASIC.

The quantum unit 200 receives the very weak signal light arriving from the transmitter 10 through the quantum channel 31 and stores the received quantization data S_{Q} _{-RCV} in the received quantization data storage section 202 as described below. The data processor 201 accesses the received quantization data S_{Q} _{-RCV} in the process of generating a quantum key as described below. The sifted key quantization data S_{Q} _{-SK} generated by the basis reconciliation section 201a is stored in the sifted key quantization data storage section 203 A corrected key K1_{B}, which is second shared information generated by the soft-decision error correction section 201b, is stored in the corrected key storage section 204. A final key QK_{B} generated by the privacy amplification section 201d is stored in the final key storage section 205.

### 1.2 Key generation process

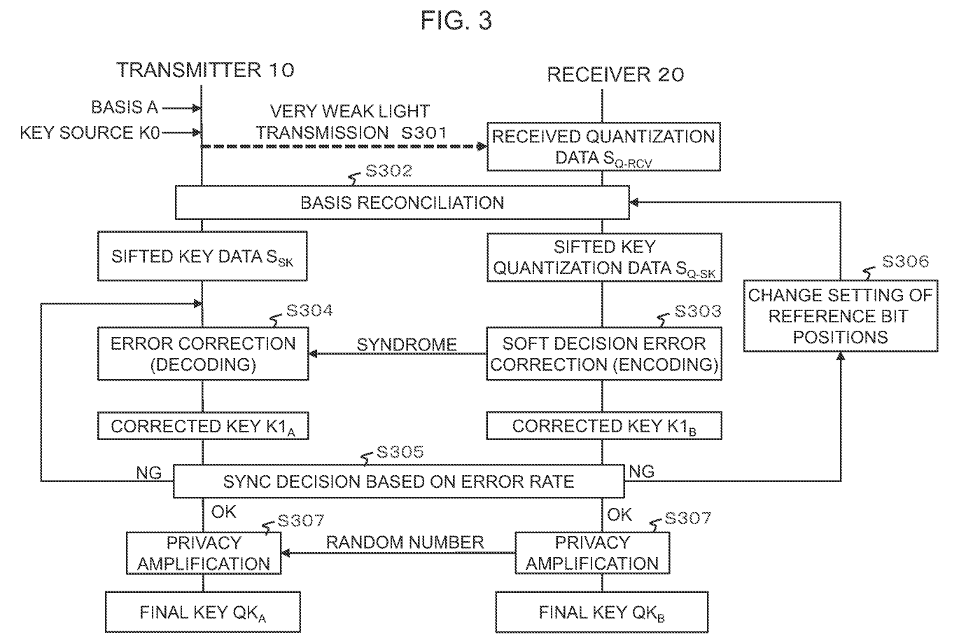

As illustrated in FIG. 3, the CV-QKD system according to the present example embodiment sequentially performs the following operations: very weak light transmission S301, basis reconciliation S302, soft-decision error correction S303 at the receiver 20, error correction S304 at the transmitter 10, synchronization decision S305, changing the setting of reference bit position S306, and privacy amplification S307. These operations are sequentially performed to generate the final keys QK_{A} and QK_{B}. The detailed description will be given with reference to FIGS. 3-6.

### Very weak light transmission

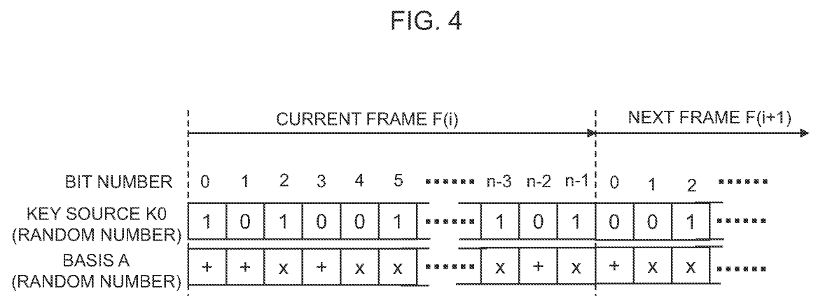

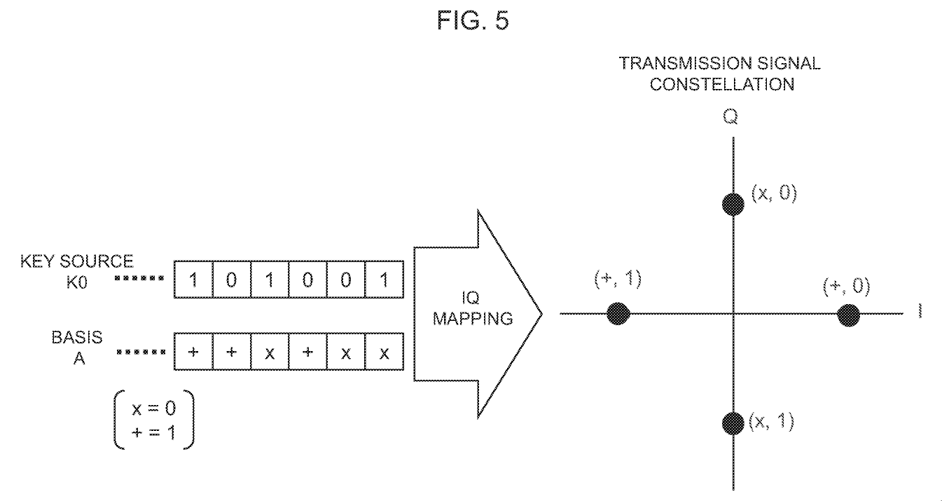

As illustrated in FIGS. 4 and 5, it is assumed that the quantum unit 100 of the transmitter 10 transmits very weak signal light quadrature-modulated according to key source K0 and basis A (S301). The key source K0 is a sequence of random numbers from which a final key is generated. The basis A is also a sequence of random numbers consisting of 0/1 which is denoted by x/+, respectively, for the sake of explanation. The random number sequences of key source K0 and basis A may be framed every predetermined number of random numbers. The random numbers in each frame may be numbered as illustrated in FIG. 4. In an example as shown in FIG. 4, a second bit position (bit number = 1) is indicated by a pair of key source K0 = "0" and basis A = "+".

As illustrated in FIG. 5, a 2-bit random number consisting of key source K0 and basis A is mapped to one of the four signal points on the IQ plane (IQ modulation). For example, if the basis A = "x", then a key source K0 = "1" is placed at the signal point (x, 1) and K0 = "0" is placed at the signal point (x, 0). In other words, I and Q signals with a phase difference of 90° correspond to the values (+/×) of basis A, respectively, and the respective signal values 0/1 correspond to the key source K0. When the basis A = "+", modulation is performed along the I axis, and when A = "×", modulation is performed along the Q axis.

Such IQ modulation can be achieved by a Mach-Zehnder QPSK (Quadrature Phase Sifted keying) modulator. In FIG. 5, a phase modulation of depth 0° is performed when (base A, key source K0) = (+, 0) and a phase modulation of depth 180° when (A, K0) = (+, 1). A phase modulation of depth 90° is performed when (A, K0) = (×, 0) and a phase modulation of depth 270° is performed when (A, K0) = (×, 1). In this manner, signal light is subjected to any one of phase modulations of 0°, 90°, 180° and 270° depending on a random sequence of key source K0 and basis A. Then very weak signal light is transmitted from the quantum unit 100 to the receiver 20 through the quantum channel 31.

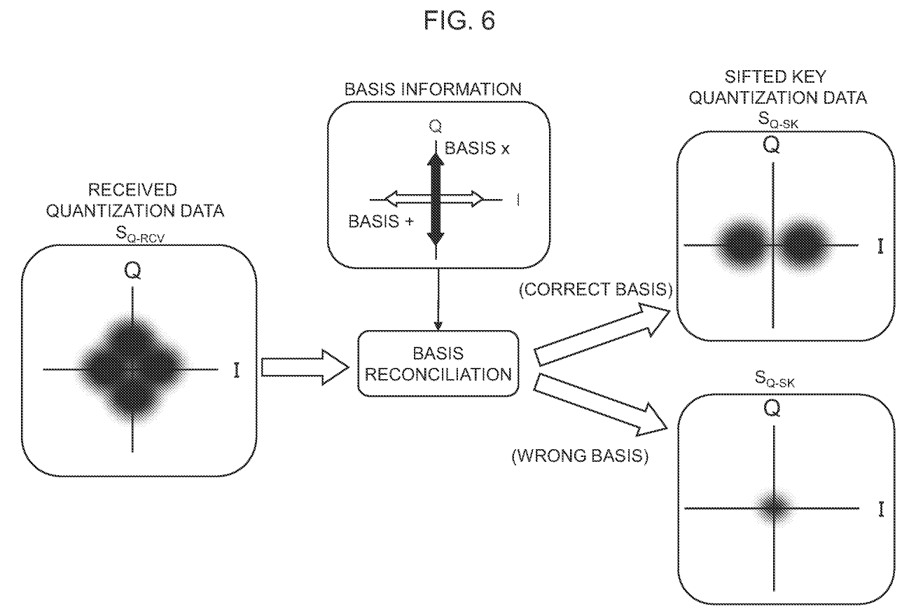

If no quantum fluctuation exists, there would be no variation in the measured values at the receiver 20 as shown in the transmission signal constellation of FIG. 5. However, quantum fluctuations cause variations in amplitude measurements of the received signal. The received state caused by quantum fluctuations may be illustrated as the received quantization data S_{Q} _{-RCV} of FIG. 6.

As illustrated in FIG. 6, the received quantization data S_{Q} _{-RCV} may be imaged as partially overlapping distributions of four states of quadrature amplitude. Accordingly, they cannot in principle be clearly distinguished. Especially when the optical power of the very weak light is less than one photon/bit, it becomes difficult to precisely distinguish which state the received data is in. The received quantization data S_{Q} _{-RCV} is quantization data of the received signal as a continuous state in which the distributions of four states of quadrature amplitude partially overlap. The data processor 201 of the receiver 20 numbers the bits in sequence as reference bit positions and stores the receive quantization data S_{Q} _{-RCV} together with the reference bit positions in the received quantization data storage section 202.

### Basis reconciliation

As illustrated in FIG. 6, if the basis A (+ or ×) of the very weak signal light generated by the transmitter 10 is obtained, then the receiver 20 can perform basis reconciliation according to the reference bit position based on the basis information to generate sifted key quantization data S_{Q} _{-SK} (S302 in FIG. 3). Assuming that the reference bit positions are correct, if the basis A is "+", then the I axis is selected for the received quantization data S_{Q} _{-RCV} to generate quantization data which is one of two regions on the I axis of IQ plane (correct basis). If basis A is "+", then the Q axis is selected for the received quantization data S_{Q} _{-RCV} to yield quantization data which is one of two regions on the Q axis of IQ plane. Accordingly, the two regions on the Q axis is rotated -90° to produce quantization data which is one of the two regions on the I axis (correct basis). In this manner, the correct basis reconciliation is performed at the correct reference bit positions, allowing sifted key quantization data to be generated. As described later, this sifted key quantization data can be subjected to the soft decision processing to determine a symbol value corresponding to the sifted key quantization data.

In contrast, if there is a misalignment of reference bit positions between the transmitter 10 and the receiver 20, basis reconciliation is performed based on erroneous basis, making correct symbol determination impossible (wrong basis). More specifically, assuming that a transmission basis A is "+" but a reception basis is "+" due to the misalignment of reference bit positions, the basis reconciliation performed based on erroneous basis generates only quantization data distributed near the origin of the IQ plane as labeled with "wrong basis" in FIG. 6. Such quantization data makes it impossible to determine which symbol the sifted key quantization data S_{Q} _{-RCV} corresponds to.

There are two methods for basis reconciliation S302. The first method is that the transmitter 10 transmits all the bases A to the receiver 20 through the classical channel 32 (first example). The second method is that the basis A of the transmitter 10 is compared to the basis B of the receiver 20 through the classical channel 32, and only the matched basis is adopted (second example).

In the transmitter 10, the data processor 101 generates sifted key data S_{S} _{K} from the key source K0 according to all or some bases adopted by the basis reconciliation and stores the sifted key data S_{S} _{K} in the sifted key data storage section 104. In the receiver 20, the data processor 201 sets reference bit positions for generating shared key, generates sifted key quantization data S_{Q} _{-SK} according to the bases adopted by basis reconciliation, and stores it in the sifted key quantization data storage 203.

### Error correction

Subsequently, the data processor 201 of the receiver 20 calculates error correction information (syndrome) of soft-decision error correction (S303 in FIG. 3). In addition, the sifted key quantization data S_{Q} _{-SK} is subjected to hard decision to generate the corrected key K1_{B}, which is a sequence of 0 and 1. The syndrome is calculated from the sifted key quantization data S_{Q} _{-SK} and the predetermined check matrix and is transmitted to the transmitter 10 through the classical channel 32.

The data processor 101 of the transmitter 10 calculates an error pattern based on the predetermined check matrix and the syndrome received from the receiver and corrects the sifted key data S_{SK} to generate the corrected key K1_{A} (S304 in FIG. 3). Accordingly, the sifted key data S_{SK} is corrected using the syndrome which is calculated based on the sifted key quantization data S_{Q} _{-SK} at the receiver 20. In other words, the sifted key of the transmitter 10 is corrected according to the sifted key quantization data of the receiver 10.

### Synchronization decision

After having generated the corrected keys K1_{A} and K1_{B} at the transmitter 10 and the receiver 20, respectively, the synchronization decision is made based on an error rate between the corrected keys K1_{A} and K1_{B} (S305 in FIG. 3). More specifically, one of the data processors 101 and 201 publicly sends, to the other, a part of key values with the same bit number between the corrected keys K1_{A} and K1_{B} through the classical channel 32. The public part at the one data processor is compared to a corresponding part at the other data processor to calculate an error rate (bit error rate).

If the error rate is not greater than a predetermined threshold, the synchronization is judged as OK. If the error rate exceeds the predetermined threshold, specifically in the neighborhood of 50 % (within a predetermined range), the synchronization is judged as NG. If there is a misalignment of reference bit positions between the transmitter 10 and the receiver 20, the corresponding parts of the corrected keys K1_{A} and K1_{B} are randomly different, which may distribute the error rate in the neighborhood of 50 %. Accordingly, the predetermined threshold can be set to a value sufficiently smaller than 50 %.

For example, if the reference bit position for generating the shared key at the receiver 20 is shifted by one bit, a random number "0" sent by the transmitter 10 with a basis "+" at bit number 1 will be received at the receiver 20 with a basis at bit number 2 instead of bit number 1. From that point on, since basis reconciliation and error correction are performed with different bits, there is no correlation between the corrected keys K1_{A} and K1_{B} generated respectively by the transmitter 10 and receiver 20. Accordingly, the bit error rate becomes a large value close to 50 %.

If synchronization is not established (NG), the data processor 201 of the receiver 20 changes the setting of reference bit positions (S306 in FIG. 3). Thereafter, basis reconciliation (S302), error correction (S303, S304), and synchronization decision (S305) are repeated as many times as necessary until the error rate is below the predetermined threshold.

### Privacy amplification

If synchronization is established (OK), the data processors 101 and 201 execute the privacy amplification processing (S307 in FIG. 3). The privacy amplification is a process of removing the amount of information that may have been leaked during the key generation process and generating new random numbers as final keys QK_{A} and QK_{B}, respectively.

### 1.3 Advantageous effect

As described above, according to the present example embodiment, the receiver generates the corrected key K1_{B} from the sifted key quantization data S_{Q-SK} by hard-decision processing, and transmits, to the transmitter 10, a syndrome (error correction information) calculated by soft-decision error correction processing. The transmitter 10 corrects the sifted key data S_{SK} using the syndrome to generate the corrected key K1_{A}. An error rate is calculated based on parts of the corrected keys K1_{A} and K1_{B} thus generated. The error rate is used to determine the success or failure of key sharing. In this manner, employing soft-decision error correction in CV-QKD can improve the error correction performance, resulting in increased key generation rate.

### 2. First example

### 2.1 System configuration

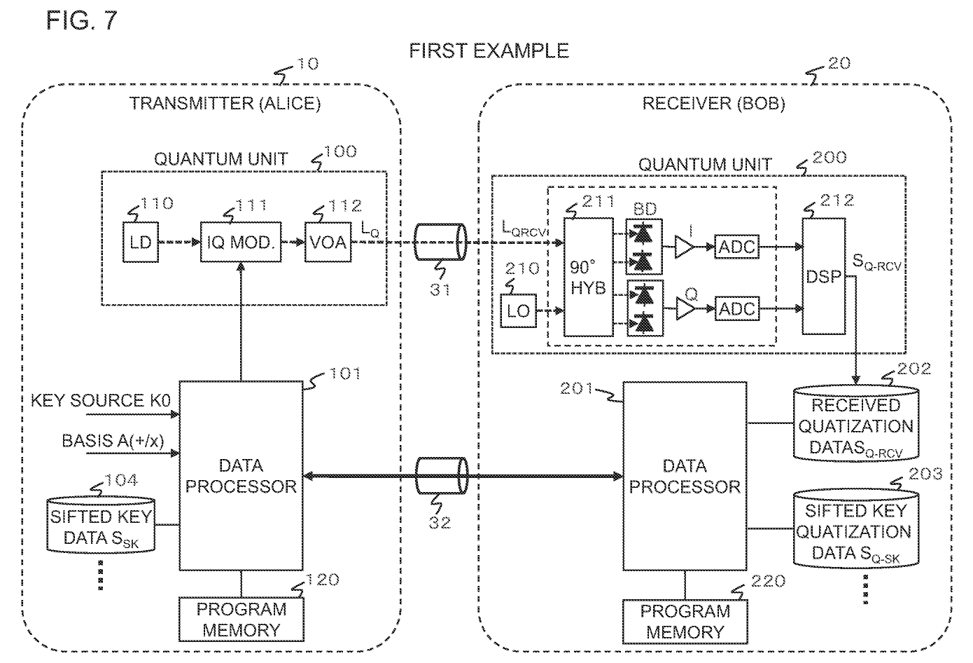

As illustrated in FIG. 7, it is assumed that a CV-QKD system according to a first example of the present invention includes a transmitter 10 and a receiver 20 which are connected through a quantum channel 31 and a classical channel 32, as in the case of the QKD system shown in FIG. 2. Hereafter, blocks similar to those previously described with reference to FIG. 2 are denoted by the same reference numerals to simplify their explanations.

The transmitter 10 according to the present example includes a quantum unit 100, a data processor 101, a sifted key data storage section 104, a random number generator 102 and a random number memory 103, a corrected key storage section 105 and a final key storage section 106, as in the above example embodiment. However, in FIG. 7, some blocks are omitted for simplification.

The quantum unit 100 of the transmitter 10 includes a laser source 110, an IQ modulator 111, and a variable attenuator (VOA) 112. In actuality, the IQ modulator 111 may be a dual-polarization IQ modulator which includes an IQ modulator for X polarization and an IQ modulator for Y polarization. The respective IQ-modulated optical signals are polarization-multiplexed and transmitted as very weak light. Each IQ modulator may be composed of two Mach-Zehnder modulators connected in parallel. A dual-polarization IQ modulator may be composed of two IQ modulators each composed of two Mach-Zehnder modulators for each polarization.

The data processor 101 controls the IQ modulator 111 according to key source K0 and basis A. The IQ modulator 111 modulates laser light emitted from the laser source 110 as shown in FIG. 5. The variable attenuator 112 attenuates the IQ-modulated laser light to a very weak level with an optical power of less than 1 photon/bit. The very weak light L_{Q} thus obtained is transmitted to the receiver 20 through the quantum channel 31.

The receiver 20 according to the present example includes a quantum unit 200, a data processor 201, a received quantization data storage section 202, a sifted key quantization data storage section 203, a corrected key storage section 204 and a final key storage section 205, as in the above example embodiment. However, in FIG. 7, some blocks are omitted for simplification.

The quantum unit 200 of the receiver 20 includes a local laser source 210, a 90° hybrid 211, balanced receivers (BDs), analog-to-digital converters (ADCs), and a digital signal processor (DSP) 212. In the case of dual-polarization IQ modulation system as described above, a detection module is provided, which polarization-demultiplexes the very weak light L_{Q} _{RCV} arriving through the quantum channel 31. The detection module includes the 90° hybrid 211, BDs and ADCs for each of X and Y polarizations.

The 90° hybrid 211 inputs the weak light L_{Q} _{RCV} and local laser light LO and interferes with them to extract the I and Q components of the electric field of the weak light L_{Q} _{RCV} (coherent detection). These I and Q components are converted into electrical signals by BDs and sampled by ADCs, respectively. The DSP 212 performs wavelength dispersion compensation, polarization demultiplexing and equalization, etc. on the sampled I and Q components to output the received quantization data S_{Q} _{-RCV}.

As described above, the reception method using interference of the very weak light L_{Q} _{RCV} and the local laser light LO is referred to as coherent detection. In coherent detection, the optical amplification effect of signal light can be obtained by interfering the signal light with the local light of a strong optical power. Accordingly, even if the power of the signal light is very weak, less than 1 photon/bit, it can be detected using a general photodetector.

Particularly, in the field of digital coherent optical receivers, an intradyne method is in the mainstream. The intradyne method does not require frequency agreement between the very weak light L_{Q} _{RCV} and the local laser light LO, but allows some frequency offset. Since effects of beat frequency due to the frequency offset can be compensated for in the DSP212, the intradyne method has advantages such that the need for high-precision wavelength control of the local laser source 210 can be eliminated.

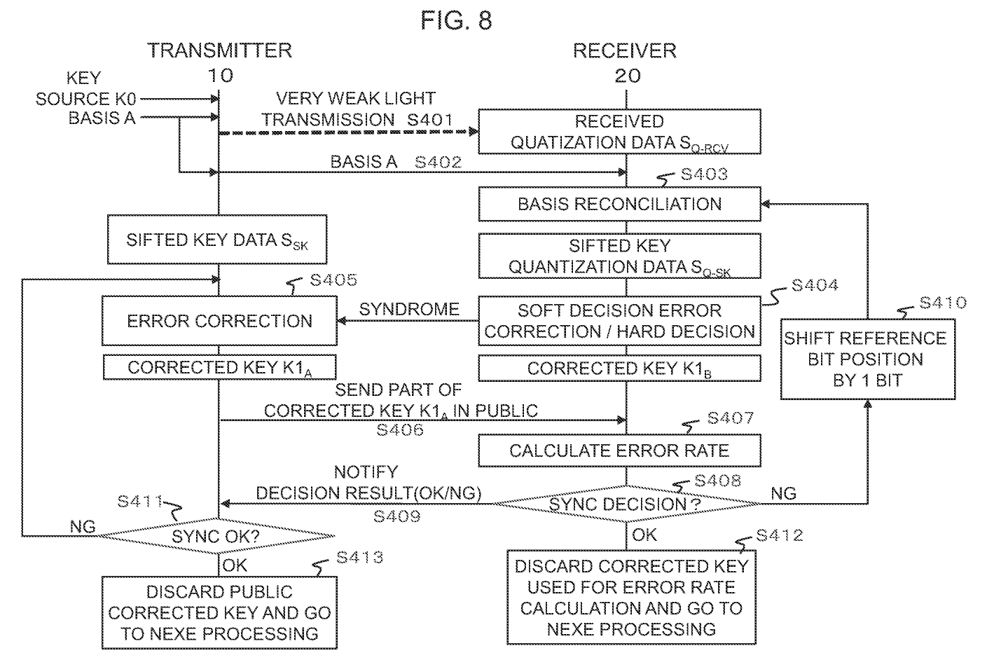

When the received quantization data S_{Q} _{-RCV} is obtained as described above, a final key is generated by the key generation process as illustrated in FIG. 8. The key generation process can be performed by executing computer programs on the data processor 101 of the transmitter 10 and the data processor 201 of the receiver 20. Such computer programs are stored in a program memory 120 of the transmitter 10 and a program memory 220 of the receiver 20, respectively.

### 2.2 Key generation process

Referring to FIG. 8, the data processor 101 of the transmitter 10 drives the IQ modulator 111 with random numbers as key source K0 and basis A (+ basis, x basis), and transmits very weak IQ-modulated signal light L_{Q} through the quantum channel 31 (operation S401). The quantum unit 200 of the receiver 20 performs coherent detection of the arriving very weak signal light L_{Q} _{RCV}. The data processor 101 assigns a serial bit number as reference bit position to each bit of received data and stores the received quantization data S_{Q-RCV} together with the reference bit positions in the received quantization data storage section 202.

When the very weak light transmission with the key source K0 and basis A has been completed, the data processor 101 of the transmitter 10 notifies the random numbers (+, ×) of basis A used for the very weak light transmission to the receiver 20 through the classical channel 32 (operation S402).

According to the reference bit positions, the data processor 201 of the receiver 20 performs basis reconciliation of the received quantization data S_{Q-RCV} based on the basis A received from the transmitter 10 as illustrated in FIG. 6 (operation S403). The basis reconciliation generates sifted key quantization data S_{Q} _{-SK}, which is stored in the sifted key quantization data storage section 203. Meanwhile, the data processor 101 of the transmitter 10 has notified all basis A to the receiver 20, and then stores the corresponding key source K0 as sifted key data S_{S} _{K} in the sifted key data storage section 104.

Subsequently, the data processor 201 of the receiver 20 calculates error correction information (syndrome) by soft-decision error correction encoding and generates a corrected key K1_{B} which is a sequence of 0 and 1 from sifted key quantization data S_{Q-SK} by hard decision (operation S404). The syndrome is calculated from the sifted key quantization data S_{Q-SK} and the predetermined check matrix, and is transmitted to the transmitter 10 through the classical channel 32.

The data processor 101 of the transmitter 10 corrects the shift key data S_{SK} using the predetermined check matrix and the syndrome received from the receiver 20 to generate the correction key K1_{A} (S405).

The transmitter 10 and the receiver 20 activate the synchronization decision function when generating the corrected keys K1_{A} and K1_{B}, respectively. In this example, the data processor 101 of the transmitter 10 transmits a part of the corrected key K1_{A} (e.g., the corrected key bit values from the beginning to a predetermined bit number) to the receiver 20 through the classical channel 32 (operation S406). Upon receiving the part of the corrected key K1_{A}, the data processor 201 of the receiver 20 compares it with a corresponding part of the corrected key K1_{B} to calculate the error rate (operation S407).

The data processor 201 of the receiver 20 determines the success or failure of synchronization by comparing the error rate with the predetermined threshold (operation S408). As an example, if the error rate is less than or equal to the predetermined threshold, the synchronization is judged as OK, and if the error rate exceeds the predetermined threshold, the synchronization is judged as NG. The predetermined threshold is set to a value sufficiently smaller than 50 %. The result of the synchronization decision (OK or NG) is notified to the transmitter 10 (operation S409).

If the synchronization decision is NG, the data processor 201 of the receiver 20 shifts the basis bit position by one bit (operation S410). Hereafter, the control returns to the basis reconciliation S403 described above and repeats the above operations (S403-S408) until the error rate is smaller than or equal to the predetermined threshold (synchronization decision OK).

If receiving the synchronization decision NG from the receiver 20 (operation S411), the data processor 101 of the transmitter 10 returns its control to the error correction S405. If a new syndrome is notified by the receiver 20, error correction is performed with the new syndrome to generate a corrected key K1_{A}. Those that follow are similar to the above-described operations.

When the error rate thus becomes smaller than or equal to a predetermined threshold (synchronization decision OK), the data processors 101 and 201 of the transmitter 10 and receiver 20 discard the bits disclosed by error correction and synchronization decision from the corrected keys K1_{A} and K1_{B}, and store the remaining corrected keys as shared keys in the corrected key storage sections 105 and 204, respectively. Subsequently, the privacy amplification processing is executed to generate the final keys QK_{A} and QK_{B} (operations S412 and S413).

If the number of synchronization NGs exceeds a predetermined number, the data processor 201 discards the current frame and terminates the process, thereby allowing basis reconciliation for the next frame to be performed with reference bit positions shifted by one bit.

### 2.3 Advantageous effect

As described above, according to the first example, soft-decision error correction is introduced to CV-QKD, which can achieve improvements of error correction performance and key generation rate. In addition, according to the first example, the transmitter 10 notifies all of the basis A to the receiver 20, allowing the receiver 20 to perform basis reconciliation using the basis A. Accordingly, the advantage is that the sifted key generation efficiency is greatly increased since the amount of key data is not reduced in the basis reconciliation.

### 3. Second example

### 3.1 System configuration

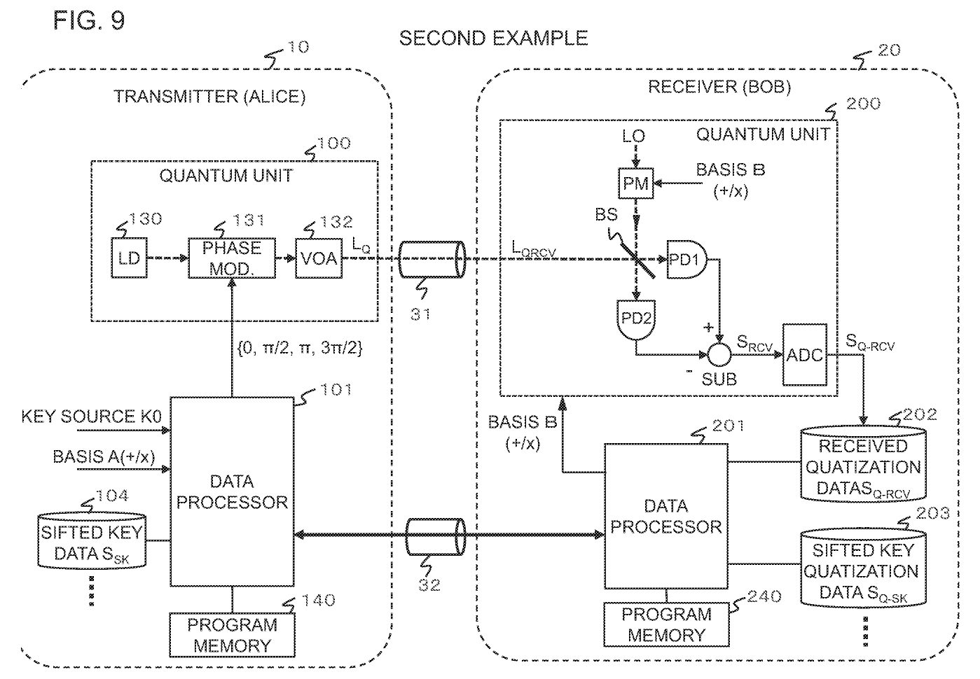

As illustrated in FIG. 9, it is assumed that a CV-QKD system according to a second example of the present invention includes a transmitter 10 and a receiver 20 which are connected through a quantum channel 31 and a classical channel 32, as in the case of the first example shown in FIG. 7. Hereinafter, the functions that differ from those in the first example will be mainly described, and blocks similar to those previously described with reference to FIG. 7 are denoted by the same reference numerals to simplify their explanations.

The transmitter 10 according to the present example includes a quantum unit 100, a data processor 101, a sifted key data storage section 104, a random number generator 102 and a random number memory 103, a corrected key storage section 105 and a final key storage section 106, as in the above example embodiment. Note that in FIG. 9 some blocks are omitted for simplification.

The quantum unit 100 of the transmitter 10 includes a laser light source 130, a phase modulator (PM) 131, and a variable attenuator (VOA) 132. The phase modulator 131 is a QPSK modulator. As shown in FIG. 5, the data processor 101 controls the phase modulator 131 such that the laser light is subjected to one phase modulation of depths 0°, 90°, 180°, and 270°according to random number sequences of key source K0 and basis A. The laser light thus phase-modulated becomes a very weak light L_{Q} having power less than 1 photon/bit by the variable attenuator 132 and is transmitted to the receiver 20 through the quantum channel 31.

As in the case of the first example, the phase modulator 131 may be a dual-polarization QPSK modulator. In the dual-polarization QPSK modulator, QPSK modulators are provided for X and Y polarizations, respectively. The QPSK-modulated optical signals are multiplexed and transmitted as very weak light.

The receiver 20 according to the present example includes a quantum unit 200, a data processor 201, a received quantization data storage section 202, a sifted key quantization data storage section 203, a corrected key storage section 204 and a final key storage section 205. Note that in FIG. 9 some blocks are omitted for simplification.

The quantum unit 200 of the receiver 20 includes a phase modulator PM, a beam splitter BS, photodetectors PD1 and PD2, a subtraction calculator SUB, and an analog-to-digital converter ADC. The phase modulator PM phase-modulates local laser light LO. The phase-modulated local laser light LO and the very weak light L_{QRCV} arriving from the transmitter 10 enter the beam splitter BS. The phase modulator PM is driven by the data processor 201 according to basis B (+, x), which is a random number.

The beam splitter BS has transmittance and reflectance in equal proportions, which superimposes the received signal light L_{Q} _{RCV} and the local laser light LO to output two outgoing beams to the photodetectors PD1 and PD2, respectively. The subtraction calculator SUB inputs detection signals of the photodetectors PD1 and PD2 to calculate a difference between the detection signals and outputs a difference signal S_{R} _{CV} to the ADC. The ADC quantizes the difference signal S_{R} _{CV} to output the received quantization data S_{Q} _{-RCV}, which is stored in the received quantization data storage section 202.

As described above, the reception method using interference of the very weak light L_{Q} _{RCV} and the local laser light LO is referred to as coherent detection. In coherent detection, the optical amplification effect of signal light can be obtained by interfering the signal light with the local light of a strong optical power. Accordingly, even if the power of the signal light is very weak, less than 1 photon/bit, it can be detected using a general photodetector.

In the case of dual-polarization phase-modulation system as described above, after polarization-demultiplexing the very weak light L_{Q} _{RCV} arriving through the quantum channel 31, the received quantization data in X and Y polarizations are obtained by the above-described quantum unit 200 provided respectively for X and Y polarization.

Furthermore, in the dual-polarization phase-modulation scheme, laser light is split into two light beams in the transmitter 10. One of the two light beams may be used to generate very weak light LQ with X polarization, and the other may be used as local laser light LO with Y polarization. In this scheme, at the receiver 20, signal light arriving from the transmitter 10 through quantum channel 31 is polarization-demultiplexed into very weak signal light L_{Q} _{RCV} on X polarization and local laser light LO on Y polarization. The very weak signal light L_{Q} _{RCV} can be interfered with the local laser light LO as described before. Such a detection method is referred to as self-homodyne detection, which has the advantage that compensation for a wavelength difference between signal light and local light is not required. However, there is a limitation on propagation distance because the local light is subjected to propagation loss through the quantum channel 31.

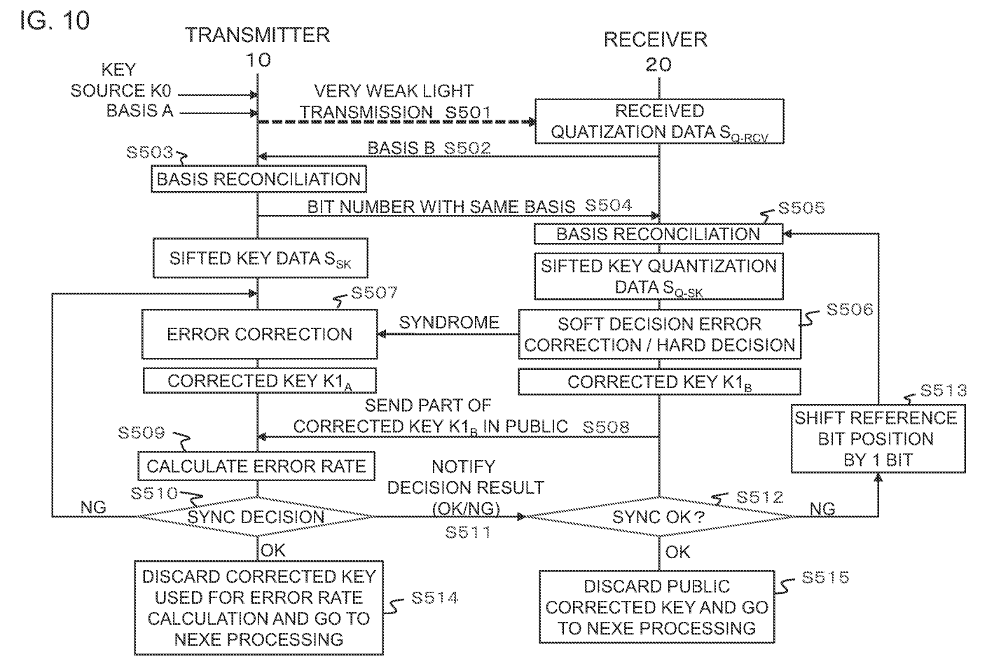

When the received quantization data S_{Q} _{-RCV} is obtained as described above, the final key is generated by the key generation process as illustrated in FIG. 10. The following key generation process can be implemented by executing a computer program stored in the program memory 140 on the data processor 101 of the transmitter 10 and a computer program stored in the program memory 240 of the receiver 20 on the data processor 201.

### 3.2 Key generation process

Referring to FIG. 10, the data processor 101 of the transmitter 10 drives the phase modulator 131 with random numbers as key source K0 and basis A (+ basis, x basis), and transmits a very weak and phase-modulated signal light L_{Q} through the quantum channel 31 (operation S501).

The data processor 201 of the receiver 20 drives the phase modulator 231 of the quantum unit 200 according to basis B on receiving side to phase-modulate the local light LO. The quantum unit 200 outputs the received quantization data S_{Q} _{-RCV} by coherent detection of interfering the local light LO phase-modulated by the phase modulator PM with the received very weak signal light L_{Q} _{RCV}. The data processor 201 assigns a sequential bit number as reference bit position and stores the receive quantization data S_{Q} _{-RCV} together with the reference bit positions in the received quantization data storage section 202.

Subsequently, the data processor 201 of the receiver 20 informs the transmitter 10 of the receiver's basis B through the classical channel 32 (operation S502).

The data processor 101 of the transmitter 10 performs basis reconciliation by matching the basis B received from the receiver 20 with the basis A of the key source K0 to store the sifted key data S_{SK} in the sifted key data storage section 104 (operation S503). In addition, the data processor 101 notifies the receiver 20 through the classical channel 32 of the bit number whose bases A and B match with each other (operation S504).

When receiving bit numbers with matched bases, the data processor 201 of the receiver 20 performs basis reconciliation of the received quantization data S_{Q} _{-RCV} stored in the received quantization data storage section 202 according to the reference bit positions (operation S505). The sifted key quantization data S_{Q} _{-SK} thus generated from the received quantization data S_{Q} _{-RCV} is stored in the sifted key quantization data storage section 203.

Hereinafter, the same data processing as in the first example is performed. That is, the data processor 201 of the receiver 20 calculates error correction information (syndrome) by soft-decision error correction encoding and generates a corrected key K1_{B} which is a sequence of 0 and 1 from sifted key quantization data S_{Q-SK} by hard decision (operation S506). The syndrome is calculated from the sifted key quantization data S_{Q-SK} and the predetermined check matrix, and is transmitted to the transmitter 10 through the classical channel 32.

The data processor 101 of the transmitter 10 corrects the shift key data S_{SK} using the predetermined check matrix and the syndrome received from the receiver 20 to generate the correction key K1_{A} (S507).

The transmitter 10 and the receiver 20 activate the synchronization decision function when generating the corrected keys K1_{A} and K1_{B}, respectively. In this example, the data processor 201 of the receiver 20 transmits a part of the corrected key K1_{B} (e.g., the corrected key bit values from the beginning to a predetermined bit number) to the transmitter 10 through the classical channel 32 (operation S508). Upon receiving the part of the corrected key K1_{B}, the data processor 101 of the transmitter 10 compares it with a corresponding part of the corrected key K1_{A} to calculate the error rate (operation S509).

The data processor 101 of the transmitter 10 determines the success or failure of synchronization by comparing the error rate with the predetermined threshold (operation S510). As an example, if the error rate is less than or equal to the predetermined threshold, the synchronization is judged as OK, and if the error rate exceeds the predetermined threshold, the synchronization is judged as NG. The predetermined threshold is set to a value sufficiently smaller than 50 %. The result of the synchronization decision (OK or NG) is notified to the receiver 20 (operation S511).

If the synchronization decision is NG, the data processor 201 of the receiver 20 shifts the basis bit position by one bit (operation S513). Hereafter, the control returns to the basis reconciliation S505 described above and repeats the above operations (S505-S513) until the error rate is smaller than or equal to the predetermined threshold (synchronization decision OK).

If the synchronization decision is NG (operation S510), the data processor 101 of the transmitter 10 returns its control to the error correction S507. If a new syndrome is notified by the receiver 20, error correction is performed with the new syndrome to generate a corrected key K1_{A}. Those that follow are similar to the above-described operations.

When the error rate thus becomes smaller than or equal to the predetermined threshold (synchronization decision OK), the data processors 101 and 201 of the transmitter 10 and receiver 20 discard the bits disclosed by error correction and synchronization decision from the corrected keys K1_{A} and K1_{B}, and store the remaining corrected keys as shared keys in the corrected key storage sections 105 and 204, respectively. Subsequently, the privacy amplification processing is executed to generate the final keys QK_{A} and QK_{B} (operations S514 and S515).

If the number of synchronization NGs exceeds a predetermined number, the data processor 201 discards the current frame and terminates the process, thereby allowing basis reconciliation for the next frame to be performed with reference bit positions shifted by one bit.

### 3.3 Advantageous effect

As described above, according to the second example, soft-decision error correction is introduced to CV-QKD, which can achieve improvements of error correction performance and key generation rate. In addition, according to the second example, both the transmitter 10 and the receiver 20 generate sifted keys only with data whose bases match, which may reduce the amount of key data but allowing efficient generation of sifted keys.

### 4. Additional notes

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with other embodiments.

The present invention may be embodied in other specific forms without departing from the spirit or essential characteristics thereof. The above-described illustrative embodiment and examples are therefore to be considered in all respects as illustrative and not restrictive, the scope of the invention being indicated by the appended claims rather than by the foregoing description, and all changes which come within the meaning and range of equivalency of the claims are therefore intended to be embraced therein. Part or all of the above-described illustrative embodiments can also be described as, but are not limited to, the following additional notes.

### Additional note 1

A method for generating a shared key by continuous-variable quantum key distribution (CV-QKD) between a first communication device and a second communication device connected through a first channel and a second channel, the method comprising:
a) at the first communication device, transmitting very weak light to the second communication device through the first channel, wherein the very weak light is quadrature-modulated according to a first random number sequence and a second random number sequence, each of which has bit positions relatively determined;
b) at the second communication device, generating received quantization data by performing coherent detection of very weak light received through the first channel;
c) at the second communication device, setting reference bit positions for shared key generation; and generating sifted key quantization data from the received quantization data according to bit positions at which the received quantization data matches with the first random number sequence, and at the first communication device, generating sifted key data according to the bit positions;
d) at the second communication device, calculating error correction information by soft-decision error correction processing on the sifted key quantization data, and transmitting the error correction information to the first communication device through the second channel;
e) at the first communication device, generating a first corrected key from the sifted key data by error correction processing using the error correction information, and at the second communication device, generating a second corrected key from the sifted key quantization data by hard-decision processing; and
f) at one of the first communication device and the second communication device, calculating an error rate based on parts of the first corrected key and the second corrected key through the second channel, and, based on the error rate, deciding whether the first corrected key and the second corrected key are the shared key.

### Additional note 2

The method according to claim 1, wherein the f) further comprises: when the error rate is not greater than a predetermined value, discarding the parts of the first corrected key and the second corrected key to generate remaining corrected keys as the shared key; and when the error rate exceeds the predetermined value, returning to the c) to change the setting of the reference bit positions.

### Additional note 3

The method according to claim 2, wherein, when the error rate exceeds the predetermined value, the c) comprises: shifting the reference bit positions by one bit.

### Additional note 4

The method according to any one of claims 1-3, wherein the c) comprises:
at the first communication device, transmitting the first random number sequence to the second communication device through the second channel; and
at the second communication device, generating sifted key quantization data from the received quantization data according to the first random number sequence.

### Additional note 5

The method according to any one of claims 1-3, wherein the c) comprises:
at the second communication device, generating a third random number sequence to transmit it to the first communication device through the second channel; and
at the first communication device, comparing the third random number sequence with the first random number sequence; and
transmitting, to the second communication device, bit positions at which the third random number sequence matches with the first random number sequence.

### Additional note 6

The method according to any one of claims 1-5, wherein each of the first communication device and the second communication device perform privacy amplification processing based on the shared key to generate a final key.

### Additional note 7

The method according to any one of claims 1-6, wherein the very weak light has an optical power of one photon or less per pulse.

### Additional note 8

A receiver connected to a transmitter through a first channel and a second channel in a continuous-variable quantum key distribution (CV-QKD) system, the receiver comprising:
a quantum unit configured to receive very weak light from the transmitter through the first channel to output received quantization data by coherent detection, wherein the very weak light is quadrature-modulated according to a first random number sequence and a second random number sequence, each of which has bit positions relatively determined; and
a data processor configured to generate a shared key from the received quantization data by communicating with the transmitter through the second channel, wherein the data processor is further configured to:
   a) set reference bit positions for shared key generation and generate sifted key quantization data from the received quantization data according to bit positions at which the received quantization data matches with the first random number sequence
   b) generate a corrected key by hard decision on the sifted key quantization data, and transmit error correction information calculated by soft-decision error correction processing on the sifted key quantization data to the transmitter through the second channel; and
   c) calculate an error rate based on a part of the corrected key and a part of transmitting-side corrected key which is generated using the error correction information at the transmitter, and decide based on the error rate whether the corrected key is the shared key or not.

### Additional note 9

The receiver according to claim 8, wherein the data processor is further configured to:
when the error rate is not greater than a predetermined value, discard the part of the corrected key to generate remaining corrected key as the shared key; and
when the error rate exceeds the predetermined value, returning to the a) to change setting of the reference bit positions.

### Additional note 10

The receiver according to claim 9, wherein the data processor is further configured to, in the a), shift the reference bit positions by one bit.

### Additional note 11

The receiver according to any one of claims 8-10, wherein the data processor is further configured to, in the a), receive the first random number sequence from the transmitter; and generate the sifted key quantization data from the received quantization data according to the first random number sequence.

### Additional note 12

The receiver according to any one of claims 8-10, wherein the data processor is further configured to, in the a), generate a third random number sequence to transmit it to the first communication device through the second channel; and receive bit positions at which the third random number sequence matches with the first random number sequence.

### Additional note 13

A transmitter connected to the receiver according to any one of claims 8-12, the transmitter comprising:
a transmitting-side quantum unit configured to transmit the very weak light to the receiver through the first channel; and
a transmitting-side data processor configured to generate the shared key based on the second random number sequence by communicating with the receiver through the second channel,
the transmitting-side data processor further configured to:
   generate sifted key data from the second random number sequence; and
   generate the transmitting-side corrected key from the sifted key data according to the error correction information received from the receiver;
   calculate a transmitting-side error rate based on a part of the corrected key and a part of the transmitting-side corrected key, and decide based on the transmitting-side error rate whether the transmitting-side corrected key is the shared key or not.

### Additional note 14

A communication control method at a receiver connected to a transmitter through a first channel and a second channel in a continuous-variable quantum key distribution (CV-QKD) system, the method comprising:
by a quantum unit, receiving very weak light from the transmitter through the first channel to output received quantization data by coherent detection, wherein the very weak light is quadrature-modulated according to a first random number sequence and a second random number sequence, each of which has bit positions relatively determined; and
by a data processor,
a) setting reference bit positions for shared key generation and generate sifted key quantization data from the received quantization data according to bit positions at which the received quantization data matches with the first random number sequence
b) generating a corrected key by hard decision on the sifted key quantization data, and transmit error correction information calculated by soft-decision error correction processing on the sifted key quantization data to the transmitter through the second channel; and
c) calculating an error rate based on a part of the corrected key and a part of transmitting-side corrected key which is generated using the error correction information at the transmitter, and decide based on the error rate whether the corrected key is the shared key or not.

### Additional note 15

The communication control method according to claim 14, wherein the c) comprises:
when the error rate is not greater than a predetermined value, discarding the part of the corrected key to generate remaining corrected key as the shared key; and
when the error rate exceeds the predetermined value, returning to the a) to change setting of the reference bit positions.

### Additional note 16

The communication control method according to claim 15, wherein the a) comprises: shifting the reference bit positions by one bit.

### Additional note 17

The communication control method according to any one of claims 14-16, wherein the a) comprises: receiving the first random number sequence from the transmitter; and generating the sifted key quantization data from the received quantization data according to the first random number sequence.

### Additional note 18

The communication control method according to any one of claims 14-16, wherein the a) comprises: generating a third random number sequence to transmit it to the first communication device through the second channel; and receiving bit positions at which the third random number sequence matches with the first random number sequence.

### Additional note 19

A program for functioning a computer as a receiver connected to a transmitter through a first channel and a second channel in a continuous-variable quantum key distribution (CV-QKD) system, the program comprising a set of instructions to:
by a quantum unit, receiving very weak light from the transmitter through the first channel to output received quantization data by coherent detection, wherein the very weak light is quadrature-modulated according to a first random number sequence and a second random number sequence, each of which has bit positions relatively determined; and
by a data processor,
a) setting reference bit positions for shared key generation and generate sifted key quantization data from the received quantization data according to bit positions at which the received quantization data matches with the first random number sequence
b) generating a corrected key by hard decision on the sifted key quantization data, and transmit error correction information calculated by soft-decision error correction processing on the sifted key quantization data to the transmitter through the second channel; and
c) calculating an error rate based on a part of the corrected key and a part of transmitting-side corrected key which is generated using the error correction information at the transmitter, and decide based on the error rate whether the corrected key is the shared key or not.

An illustrative example embodiment or example is applicable to CV-QKD systems.

### DESCRIPTION OF SIGNS

10 Transmitter
20 Receiver
31 Quantum channel
32 Classic channel
100 Quantum unit
101 Data Processor
101a Basis reconciliation section
101b Error correction section
101c Privacy amplification section
102 Random number generator
103 Random number memory
104 Sifted key data storage section
105 Corrected key storage section
106 Final key storage section
200 Quantum unit
201 Data Processor
201a Basis reconciliation section
201b Soft-decision error correction section
201c Bit position synchronization decision section
201d Privacy amplification section
202 Received quantization data storage section
203 Sifted key quantization data storage section
204 Corrected key storage section
205 Final key storage section

1. A communication device connected to another communication device through a first channel and a second channel in a continuous-variable quantum key distribution (CV-QKD) system, the communication device comprising:
a quantum unit configured to receive signal light from the another communication device through the first channel to generate received quantization data by coherent detection, wherein the signal light is quadrature-modulated according to a first random number sequence and a second random number sequence which have predetermined bit positions at the another communication device; and
at least one data processor configured to generate a shared key from the received quantization data by communicating with the another communication device through the second channel,
wherein the at least one data processor is further configured to:
a) set reference bit positions for basis reconciliation with the another communication device, wherein the basis reconciliation generates sifted key quantization data from the received quantization data according to the reference bit positions ;
b) perform hard decision on the sifted key quantization data to generate a corrected key;
c) perform soft-decision error correction processing on the sifted key quantization data to generate error correction information to transmit the error correction information to the another communication device through the second channel; and
d) decide whether synchronization is established or not, based on an error rate between the corrected key and another corrected key, wherein the another corrected key is generated based on the error correction information at the another communication device.

2. The communication device according to claim 1, wherein the data processor is further configured to:
if the error rate is not greater than a predetermined value, discard a part of the corrected key used for synchronization decision to generate remaining corrected key as a shared key with the another communication device; and
if the error rate exceeds the predetermined value, return to the a) to change setting of the reference bit positions.

3. The communication device according to claim 2, wherein the data processor is further configured to, in the a), shift the reference bit positions by one bit.

4. The communication device according to claim 1, wherein the data processor is further configured to, in the a), receive the first random number sequence from the another communication device; and generate the sifted key quantization data from the received quantization data according to the first random number sequence.

5. The communication device according to claim 1, wherein the data processor is further configured to, in the a), generate a third random number sequence to transmit it to the another communication device through the second channel; and receive, from the another communication device, bit positions at which the third random number sequence matches with the first random number sequence.

6. The another communication device connected to the communication device according to claim 1, the another communication device comprising:
another quantum unit configured to transmit the signal light to the communication device through the first channel; and
another data processor configured to generate the shared key based on the second random number sequence by communicating with the communication device through the second channel,
the another data processor further configured to:
generate sifted key data from the second random number sequence by the basis reconciliation;
generate the another corrected key from the sifted key data according to the error correction information received from the communication device;
decide whether synchronization is established or not, based on an error rate between the another corrected key and the corrected key.

7. A communication control method at a communication device connected to another communication device through a first channel and a second channel in a continuous-variable quantum key distribution (CV-QKD) system, the method comprising:
by a quantum unit, receiving signal light from the another communication device through the first channel to generate received quantization data by coherent detection, wherein the signal light is quadrature-modulated according to a first random number sequence and a second random number sequence which have predetermined bit positions at the another communication device; and
by at least one data processor,
a) setting reference bit positions for basis reconciliation with the another communication device, wherein the basis reconciliation generates sifted key quantization data from the received quantization data according to the reference bit positions ;
b) performing hard decision on the sifted key quantization data to generate a corrected key;
c) performing soft-decision error correction processing on the sifted key quantization data to generate error correction information to transmit the error correction information to the another communication device through the second channel; and
d) deciding whether synchronization is established or not, based on an error rate between the corrected key and another corrected key, wherein the another corrected key is generated based on the error correction information at the another communication device.

8. The communication control method according to claim 7, wherein the d) comprises:
when the error rate is not greater than a predetermined value, discarding a part of the corrected key used for synchronization decision to generate remaining corrected key as a shared key with the another communication device; and
when the error rate exceeds the predetermined value, returning to the a) to change setting of the reference bit positions.

9. The communication control method according to claim 8, wherein the a) comprises: shifting the reference bit positions by one bit.

10. The communication control method according to claim 7, wherein the a) comprises:
receiving the first random number sequence from the another communication device; and
generating the sifted key quantization data from the received quantization data according to the first random number sequence.

11. The communication control method according to claim 7, wherein the a) comprises:
generating a third random number sequence to transmit it to the another communication device through the second channel; and
receiving, from the another communication device, bit positions at which the third random number sequence matches with the first random number sequence.

12. A method for generating a shared key by continuous-variable quantum key distribution (CV-QKD) between a first communication device and a second communication device connected through a first channel and a second channel, the method comprising:
a) at the first communication device, transmitting signal light to the second communication device through the first channel, wherein the signal light is quadrature-modulated according to a first random number sequence and a second random number sequence which have predetermined bit positions at the first communication device;
b) at the second communication device, generating received quantization data by performing coherent detection of signal light received through the first channel;
c) at the second communication device, setting reference bit positions for basis reconciliation with the first communication device, wherein the basis reconciliation generates sifted key quantization data from the received quantization data according to the reference bit positions ;
d) at the first communication device, generating sifted key data by the basis reconciliation;
e) at the second communication device,
calculating error correction information by soft-decision error correction processing on the sifted key quantization data, and
transmitting the error correction information to the first communication device through the second channel;
f) at the first communication device, generating a first corrected key from the sifted key data by error correction processing using the error correction information;
g) at the second communication device, generating a second corrected key from the sifted key quantization data by hard-decision processing; and
h) at one of the first communication device and the second communication device, deciding whether synchronization is established or not, based on an error rate between the first corrected key and the second corrected key.

13. The method according to claim 12, wherein the h) further comprises:
when the error rate is not greater than a predetermined value, discarding parts of the first corrected key and the second corrected key used for synchronization decision, to generate remaining corrected keys as a shared key; and
when the error rate exceeds the predetermined value, returning to the c) to change the setting of the reference bit positions.

14. The method according to claim 13, wherein, when the error rate exceeds the predetermined value, the c) comprises: shifting the reference bit positions by one bit.

15. The method according to claim 12, wherein the c) comprises:
at the first communication device, transmitting the first random number sequence to the second communication device through the second channel; and
at the second communication device, generating sifted key quantization data from the received quantization data according to the first random number sequence.

16. The method according to claim 12, wherein the c) comprises:
at the second communication device, generating a third random number sequence to transmit it to the first communication device through the second channel; and
at the first communication device,
comparing the third random number sequence with the first random number sequence; and
transmitting, to the second communication device, bit positions at which the third random number sequence matches with the first random number sequence.

17. The method according to claim 12, wherein each of the first communication device and the second communication device perform privacy amplification processing based on the shared key to generate a final key.

18. The method according to claim 12, wherein the signal light has an optical power of one photon or less per pulse.
